(19) United States
(12) Patent Application Publication
(10) Pub. No.: US 2025/0264572 A1
(43) Pub. Date: Aug. 21, 2025

(54) IMAGING RADAR SYSTEM WITH DISTRIBUTED ANTENNA ARRAY

(71) Applicant: Sensoride Corporation, San Diego, CA (US)

(72) Inventors: Hassan Daniel Moradi, San Diego, CA (US); Ashish Basireddy, San Diego, CA (US)

(73) Assignee: Sensoride Corporation, San Diego, CA (US)

(21) Appl. No.: 19/044,564

(22) Filed: Feb. 3, 2025

Related U.S. Application Data
(60) Provisional application No. 63/556,002, filed on Feb. 21, 2024.

(51) Int. Cl. G01S 7/03; G01S 13/89

(52) U.S. Cl. CPC G01S 7/03; G01S 13/89

(57) ABSTRACT

A radar system comprises a physical radar array including a plurality of physical transmit antennas, each configured to transmit a respective signal having a wavelength λ. The physical radar array further comprises a plurality of physical receive antennas, each configured to receive each of the respective transmitted signals. At least one of the plurality of physical receive antennas is positioned at a different elevation than the other receive antennas. In some embodiments at least one of the plurality of physical transmit antennas is positioned at a different elevation than the other transmit antennas. In some embodiments the radar system further comprises a neural network arranged to receive data from the physical radar array and to generate or update data for one or more missing virtual antennas, generate a new fraction of the virtual antennas, generate the full set of virtual antennas, or directly generate the processed data.

### CROSS-REFERENCES TO OTHER APPLICATIONS

This application claims priority to U.S. provisional patent application Ser. No. 63/556,002, for “RADAR SYSTEM WITH MACHINE LEARNING-ENHANCED ANTENNA ARRAY” filed on Feb. 21, 2024, U.S. non-provisional patent application Ser. No. 18/891,432, for “RADAR SYSTEM WITH MACHINE LEARNING-ENHANCED ANTENNA ARRAY” filed on Sep. 20, 2024 and U.S. non-provisional patent application Ser. No. 18/891,798, for “RADAR SYSTEM WITH WAVELENGTH INDEPENDENT ANTENNA ARRAY” filed on Sep. 20, 2024 which are each hereby incorporated by reference in their entirety for all purposes.

### FIELD

The described embodiments relate generally to radar systems such as radar arrays that employ one or more transmitters and one or more receivers. More particularly, the present embodiments relate to multiple input and multiple output (MIMO) radar systems that include at least one receive antenna at a different elevation than the other receive antennas.

### BACKGROUND

Currently there are a wide variety of radar systems that use MIMO antenna arrangements. However, current MIMO radar systems have limited resolution in the elevation dimension because they are limited to only having transmit antennas that have different elevations. Further, current MIMO radar systems are limited to the separate processing of azimuth and elevation data. New radar systems are required that have one or more receive and/or antennas at a different elevation and/or that perform joint processing of azimuth and elevation data to provide improved resolution in the elevation dimension.

### SUMMARY

In some embodiments, a radar system comprises a physical radar array including a plurality of physical transmit antennas, each configured to transmit a respective signal having a wavelength 1. The physical radar array further comprises a plurality of physical receive antennas, each configured to receive each of the respective transmitted signals. At least a first physical receive antenna is at an elevation that is different than a second physical receive antenna.

In some embodiments, the radar system further comprises a processor arranged to receive data from the physical radar array and to generate data for a two-dimensional virtual antenna array. A spacing between a first and a second virtual antenna of the virtual antenna array is greater than

$$\frac{λ}{2} .$$

In some embodiments, the processor is further arranged to generate data for a supplemental virtual antenna positioned between the first and the second virtual antenna. In various embodiments, the processor employs a trained neural network to generate the data. In some embodiments, a distance between the first virtual antenna and the supplemental virtual antenna is

$$\frac{λ}{2} .$$

A distance between the second virtual antenna and the supplemental virtual antenna is

$$\frac{λ}{2} .$$

In some embodiments, at least a first physical transmit antenna is at an elevation that is different than a second physical transmit antenna. In various embodiments, the radar system further comprises a processor arranged to receive data from the physical radar array and to generate data for a two-dimensional emulated virtual antenna array. In some embodiments, a horizontal distance between each virtual antenna of the emulated virtual antenna array is

$$\frac{λ}{2} .$$

In various embodiments, the processor employs a trained neural network to generate the data for the two-dimensional emulated virtual antenna array.

In some embodiments a radar system comprises a physical transmit antenna configured to transmit a signal having a wavelength 1. Additionally, the radar system comprises a first physical receive antenna positioned at a first vertical position and arranged to receive a reflected signal corresponding to the transmitted signal. The radar system further comprises a second physical receive antenna positioned at a second vertical position and arranged to receive the reflected signal corresponding to the transmitted signal. The first vertical position is higher than the second vertical position.

In some embodiments, the radar system further comprises a processor arranged to receive data from the first physical receive antenna and from the second physical receive antenna. The processor is further arranged to generate data for a two-dimensional virtual antenna array. A spacing between a first and a second virtual antenna is greater than

$$\frac{λ}{2} .$$

In various embodiments, the processor is further arranged to generate data for a supplemental virtual antenna positioned between the first and the second virtual antennas. In some embodiments, the processor employs a trained neural network to generate the data. In various embodiments, a distance between the first virtual antenna and the supplemental virtual antenna is

$$\frac{λ}{2}$$

and a distance between the second virtual antenna and the supplemental virtual antenna is

$$\frac{λ}{2} .$$

In some embodiments, the radar system further comprises a processor arranged to receive data from the first physical receive antenna and from the second physical receive antenna. The processor is further arranged to generate data for a two-dimensional emulated virtual array. In various embodiments, the processor employs a trained neural network to generate the data such that a horizontal distance between each virtual antenna of the emulated virtual antenna array is

$$\frac{λ}{2} .$$

In some embodiments, a method of operating a radar system comprises transmitting a signal from a physical transmit antenna at a wavelength 1. The method further comprises receiving a reflected signal at a first physical receive antenna positioned at a first elevation. The reflected signal corresponds to the transmitted signal. Additionally, the method comprises receiving the reflected signal at a second physical receive antenna positioned at a second elevation. The first elevation is greater than the second elevation.

In some embodiments, the method further comprises generating, using a processor, data corresponding to a virtual antenna array. A horizontal distance between a first antenna of the virtual antenna array and a second virtual antenna of the virtual antenna array is greater than λ/2. In various embodiments, the method further comprises generating, by the processor, data for a supplemental virtual antenna positioned between the first virtual antenna and the second virtual antenna. In some embodiments, the method further comprises generating, using a processor, data corresponding to an emulated virtual antenna array. A horizontal distance between a first virtual antenna of the virtual antenna array and a second virtual antenna of the virtual antenna array is λ/2.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1A is a simplified diagram of a physical radar system having receive antennas at different elevations, according to embodiments of the disclosure;

FIG. 1B is a simplified diagram of a virtual antenna array generated from the physical radar system shown in FIG. 1A;

FIG. 1C is a simplified diagram of a first supplemented virtual antenna array shown in FIG. 1B;

FIG. 1D is a simplified diagram of a second supplemented virtual antenna array shown in FIG. 1B;

FIG. 1E is a simplified diagram of an emulated virtual antenna array based on the physical radar system shown in FIG. 1A;

FIG. 2 is an example block diagram of how a radar system may work, according to embodiments of the present disclosure;

FIG. 3 is an illustration of a simplified model of one embodiment of a generation of antennas inside a neural network model, according to some aspects of the present disclosure;

FIG. 4 is an illustration of a machine learning-based neural network model, according to embodiments of the present disclosure;

FIG. 5 is an illustration of example steps associated with training a machine learning model, according to embodiments of the present disclosure;

FIG. 6 is a flow chart for a simplified example process for generating training data for a machine learning model, according to embodiments of the present disclosure;

FIG. 7A is an example of fully or partially processed output data that may be generated by a neural network, according to embodiments of the disclosure;

FIG. 7B illustrates an example fully or partially processed output data that may be generated by a neural network;

FIG. 8 is a simplified block diagram of an example processor that may be used to operate a radar system, according to embodiments of the disclosure; and

FIG. 9 illustrates a simplified architecture of a model integrated into a hardware-accelerated system based on e.g., an FPGA, to generate fully or partially processed output data from a neural network, according to embodiments of the disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to radar systems. More specifically, techniques disclosed herein relate to radar systems that use one or more receive antennas positioned at different elevations to provide improved elevation resolution. Techniques are also disclosed that enable joint processing of azimuth and elevation data. Various inventive embodiments are described herein, including methods, processes, systems, devices, and the like.

For example, in some embodiments a multiple input multiple output (MIMO) radar system employs multiple physical transmit antennas and multiple physical receive antennas to determine azimuth and elevation information for a target. At least one physical receive antenna has an elevation that is different than an elevation of the other physical receive antennas. The different elevation of the one or more receive antennas results in a virtual antenna array with at least two horizontal rows of virtual antennas, providing elevation resolution for the position of the target. In some embodiments more than one physical receive antenna has an elevation that is different than the others, yielding an increased number of horizontal rows of virtual antennas for further improvements in elevation resolution. In various embodiments, one or more of the transmit antennas may also have an elevation that is different than the other transmit antennas and when used with a physical receive antenna array that includes antennas at various elevations the number of rows of virtual antennas in the virtual array are multiplied for yet further improvements in elevation resolution.

In some embodiments the virtual antenna array may have virtual antennas with non-uniform spacing therebetween such that one or more “gaps” are present between adjacent virtual antennas. A neural network can be used to generate data for supplemental virtual antennas that fill in the one or more “gaps” so the supplemented virtual antenna array has an array of virtual antennas with uniform spacing therebetween. In further embodiments an emulated virtual antenna array that has uniform spacing between the virtual antennas may be generated by a neural network, where the neural network generates data for all of the virtual antennas instead of generating data only for the “missing” antennas.

In some embodiments the neural network may directly generate fully or partially processed output data, without generating a virtual antenna array. More specifically, the neural network may generate output data in the form of numeric data (e.g., azimuth, elevation and/or amplitude data), graphical output data, bitmap output data, point cloud output data, or any other suitable format of final output data directly without generating data corresponding to a virtual antenna array. In various embodiments the neural network may be trained to directly generate fully or partially processed output data based on various different input data, such that the neural network generates the final output data without calculating and/or generating data representative of a virtual antenna array.

Compared to conventional radar systems, the radar systems disclosed herein provide virtual antenna arrays with improved elevation and azimuth resolution and/or may generate fully or partially processed output data without generating intermediate virtual antenna array data. These and other features of the embodiments described herein are disclosed in more detail below.

In order to better appreciate the features and aspects of radar systems having one or more physical receive antennas at different elevations according to the present disclosure, further context for the disclosure is provided in the following section by discussing one particular implementation of a radar system according to embodiments of the present disclosure. These embodiments are for example only and other embodiments may have different radar layouts, different system architectures and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

### Neural Network-Enhanced Antenna Array

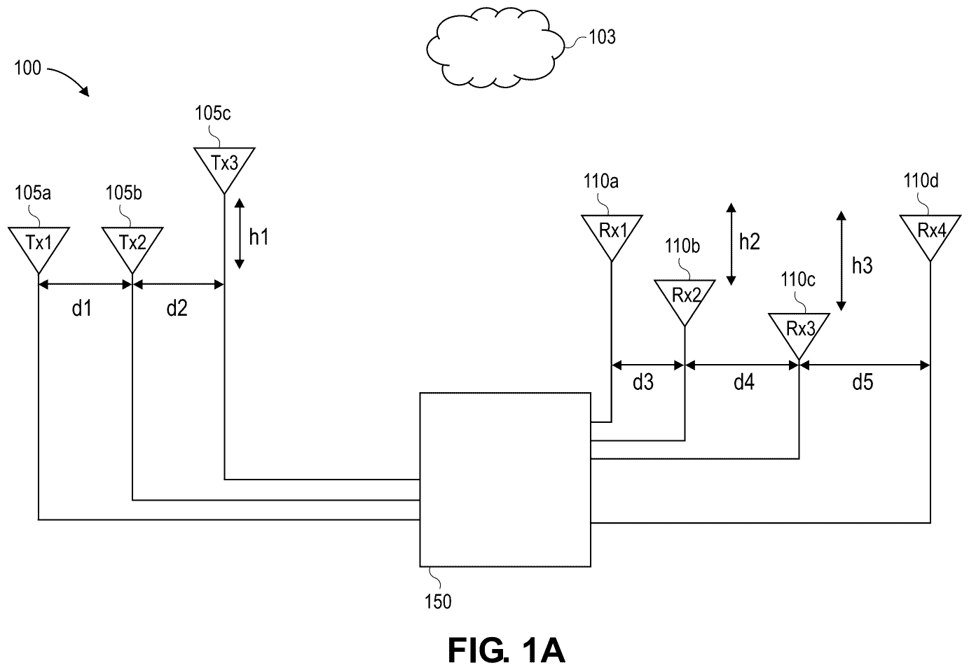

FIG. 1A illustrates a simplified diagram of a radar system 100 having physical receive and transmit antennas at different elevations (also referred to herein as vertical offset, elevation and position), according to embodiments of the disclosure. As shown in FIG. 1A, radar system 100 includes three physical transmit antennas Tx1 105a, Tx2 105b, and Tx3 105c that each transmit signals at a wavelength λ that are reflected off of one or more targets 103. Tx1 105a is separated from adjacent Tx2 105b by horizontal spacing d1, Tx2 105b is separated from adjacent Tx3 105c by horizontal spacing d2, and Tx3 105c has a vertical offset or elevation of h1 relative to Tx1 105a and Tx2 105b. There are also four physical receive antennas that receive signals reflected off of the one or more targets 103 and that correspond to the transmitted signals from the transmit antennas. Receive antenna Rx1 110a is separated from Rx2 110b by horizontal spacing d3, Rx3 110c separated from Rx2 110b by horizontal spacing d4 and Rx4 110d is separated from Rx3 110c by horizontal spacing d5. Rx1 110a and Rx4 110d have a same elevation. Rx2 110b has a vertical offset or elevation difference of h2 relative to Rx1110a and Rx4 110d, and Rx3 110c has a vertical offset or elevation difference of h3 relative to Rx1 110a and Rx4 110d. In some embodiments the horizontal spacings d1, d2, d3, d4, and d5, and the elevations h1, h2, and h3 may be integer multiples of λ/2 (e.g., wavelength dependent) while in other embodiments one or more of the horizontal spacings and the elevations may be any non-integer or fractional multiple of λ/2 (e.g., wavelength independent).

As appreciated by one of skill in the art having the benefit of this disclosure, although FIG. 1A illustrates four receive antennas 110 having three different elevations, other embodiments may have a greater or lesser number of receive antennas that may be at one, two, four or more different elevations. In one embodiment there are three receive antennas at two different elevations.

As described herein, “wavelength independent” spacing is when one or more of the vertical and/or horizontal distances between adjacent antennas is not λ/2-based, which is the traditional “wavelength dependent” spacing between antennas. More specifically, the radar systems disclosed herein can use any suitable spacing between physical antenna elements and therefore can be considered “wavelength independent” as defined herein. Further, even though some distances between adjacent antennas are described herein using the term λ, (e.g., 1.3λ/2) the use of λ does not mean the distance between the antennas is “wavelength dependent”, in particular, when used with a non-integer value of λ or when any spacing between physical antennas is not λ/2-based spacing. Rather, the use of λ in such ways herein is merely one way to describe the spacing between antennas as related to a transmission wavelength of the physical transmit antennas.

Each physical transmit and receive antenna, respectively, is connected to a processor 150 that controls each antenna and may more specifically control the transmission operations of the transmit antennas and the received data from the receive antennas. Processor 150 may be any suitable processing system including but not limited to a radio frequency (RF) system-on-chip (SOC), a local and/or remote computing system or a combination of computing systems. Although radar system 100 depicts seven physical antennas with a particular spacing (e.g., d1-d5, h1-h3) between each antenna, one of skill in the art having the benefit of this disclosure will appreciate that this invention is not limited to this embodiment and that any suitable number of physical transmit and receive antennas can be used and the horizontal spacing or vertical offset therebetween may be any suitable distance.

As described in more detail below, by having at least one receive antenna at a different elevation than the other receive antennas, each resulting virtual antenna may provide both azimuth and elevation data for one or more targets. By having one or more additional receive antennas at different relative elevations than the other receive antennas, further improvements in elevation resolution may be achieved.

FIG. 1B illustrates a virtual antenna array 110 that is formed from radar system 100, where the virtual antenna array has multiple rows of virtual antennas that provide azimuth and elevation data for a target, as described in more detail below. More specifically, virtual antenna array 110 can be created from a combination of the physical transmit antennas and the physical receive antennas via digital signal processing performed by the processor 150 shown in FIG. 1A. When multiple physical transmit and receive antennas are co-located, they can function together to form what is commonly known as a virtual antenna array 110. The virtual antenna array 110 is not a set of physical antennas, rather it is a mathematically equivalent construct that describes the behavior of the antenna array. The number of virtual elements in a traditional planar virtual antenna array having “N” physical transmit antennas and “M” physical receive antennas is the product of N and M, however if any of the physical antennas have wavelength independent (e.g., non-λ/2-based spacing) the virtual antennas do not have consistent spacing therebetween and a number of gaps, as shown, results. Note that the spacing between physical antennas or virtual antennas do not need to be equal.

More specifically, as shown in FIG. 1B, there are four rows (109, 111, 113 and 115) of virtual antennas that result from the different elevations of the physical receive antennas and the different physical elevations of the transmit antennas. As appreciated by one of skill in the art having the benefit of this disclosure, when at least one of the physical transmit or receive antennas has a different elevation than the other physical transmit or receive antennas at least two rows of virtual antennas will result providing elevation information (e.g., two rows of data as compared to one row of data). When combined with one or more transmit antennas at different elevations the number of rows of virtual antennas is multiplied resulting in yet further improved elevation resolution.

Describing FIG. 1B in greater detail, radar system 100 may employ digital signal processing to create the virtual antenna array 110 of twelve virtual receive antennas from the signals sent to and/or received from the three physical transmit antennas Tx1, Tx2, Tx3, and the four physical receive antennas Rx1, Rx2, Rx3, Rx4. The twelve virtual receive antennas can populate four rows (e.g., rows 109, 111, 113, and 115) and be divided into three groups (e.g., groups 106, 107 and 108). The virtual receive antennas in group 106 can be associated with physical transmit antenna Tx1, the virtual receive antennas in group 107 can be associated with physical transmit antenna Tx2 and the virtual receive antennas in group 108 can be associated with physical transmit antenna Tx3.

As further shown in FIG. 1B, for each of the rows (109-115), one or more missing virtual antennas may form “gaps” (horizontal spaces between adjacent virtual antennas that are multiples of λ/2) in the virtual antenna array 110 and thus the virtual antenna array may not have uniform phase consistency. The combination of the virtual antennas and the missing virtual antennas each have a consistent defined distance “d” between them where d=λ/2. The virtual antenna array 110 has e.g., sparsity, irregular or inconsistent spacing between virtual antennas because of the missing virtual antennas (e.g., antennas that are missing at λ/2 spacing). For example, the space between two virtual antennas in row 109 is 3 d, whereas the space between two virtual antennas in row 115 is 4 d. As described in more detail below, the neural network may be used to “fill in” the gaps by calculating data for supplemental virtual antennas or by generating an emulated virtual antenna array, described in more detail below. Each virtual antenna in the virtual antenna array 110 can contribute both elevation and azimuthal information to track one or more targets.

FIG. 1C illustrates the example virtual antenna array 110 shown in FIG. 1B, with missing virtual antennas filled in with supplemental virtual antennas in each of the groups 106-108, forming a first supplemented virtual antenna array 120. Each of the groups 106-108 of the supplemented virtual antenna array 120 includes twelve generated virtual antenna elements (shown in dashed lines) to create three groups of 16 antennas each, where the spacing between each adjacent virtual antenna is λ/2. This provides a virtual array having uniform angular resolution and phase consistency. More specifically, processor 150 (see FIG. 1A) may employ a neural network, machine learning process, extrapolation calculation or other suitable algorithm to generate data for each supplemental virtual antenna such that processor 150 can detect targets uniformly across all 36 antenna elements. Processor 150 may use data from the physical transmit antennas (see FIG. 1A) and the physical receive antennas to generate data for the supplemental virtual antennas. As shown in FIG. 1C, the number of virtual antennas for the supplemented virtual array 120 is the product of M and N (three times four) plus the number of supplemental virtual antennas (in this case there are 24) so in this example there are 36 virtual antennas. As appreciated by a person of ordinary skill in the art having the benefit of this disclosure processor 150 may include one or more processors that work in conjunction with each other. In one example embodiment a first processor is an RF ASIC that communicates with the physical antennas, a second process is used for data transfer and a third processor is used for the neural network processing.

The neural network can be trained based on a machine learning model, including Deep Neural Networks (DNN), convolutional neural network (CNN) or any other suitable type of training, some of which can be based on a neural network. In some embodiments the neural network may undergo training to understand patterns and correlations within the available radar data, enabling the network to estimate the signals for the supplemental virtual antennas that are missing in the virtual array and send corresponding data to processor 150. In some embodiments the neural network can produce data for each supplemental virtual antenna which can be used in combination with the data from each virtual antenna to generate data for the uniform supplemented virtual array 120. In various embodiments the neural network may be integrated into processor 150 and/or may form a portion of a system-on-a-chip. In some embodiments d, which is a spacing between each element of the first supplemented virtual array 120, is λ/2. In some embodiments a neural network may not be employed and one or more processors may generate data corresponding to the supplemental virtual antennas using an extrapolation calculation or other suitable algorithm.

As appreciated by one of ordinary skill in the art having the benefit of this disclosure, in some embodiments, when the field of view of the system is greater than or less than 180 degrees, the optimal spacing between each antenna of the first supplemented virtual array 120 may be greater than or less than λ/2 and may be referred to more generally as a “predetermined distance”. For example, in one embodiment a desired field of view of the first supplemented virtual array 120 is 120 degrees and therefore the optimal predetermined distance between each antenna of the supplemented virtual antenna array is greater than λ/2. In various embodiments the predetermined distance may be λ/2 while in other embodiments the predetermined distance may be greater or less than λ/2. Each virtual antenna (including virtual antennas and supplemented virtual antennas) in the first supplemented virtual array 120 can contribute both elevation and azimuthal information to track one or more targets.

FIG. 1D illustrates the example virtual antenna array 110 shown in FIG. 1B, with missing virtual antennas filled in with supplemental virtual antennas (shown with dashed lines) in each of the rows 109, 111, 113, and 115 forming a second supplemented virtual antenna array 130. The second supplemental virtual array 130 can include any of the components or features described in any other virtual antenna array described in this application, including first supplemental virtual antenna array 120. Each of the rows 109, 111, 113, and 115 of the second supplemented virtual antenna array 130 includes a filled line of twelve virtual antenna elements at regularly spaced elements at a distance d (where d=λ/2), providing a virtual array of antennas with uniform angular resolution and phase consistency.

More specifically, processor 150 (see FIG. 1A) may employ a neural network, machine learning process, extrapolation calculation or other suitable algorithm to generate data for each supplemental virtual antenna such that processor 150 can detect targets uniformly across all 48 antenna elements. Processor 150 can be a combination of two or more processors and/or controllers, including a system-on-a-chip (SOC). Processor 150 may use data from the physical transmit antennas (see FIG. 1A) and the physical receive antennas to generate data for the supplemental virtual antennas. As shown in FIG. 1D, the number of virtual antennas for the second supplemental virtual array 130 is the product of M and N (three times four) plus the number of supplemental virtual antennas (in this case there are 36) so in this example there are 48 virtual antennas (e.g., 12 in each row). The number of generated supplemental virtual array antennas may be determined by the processor 150 and can be set at any suitable number. As appreciated by a person of ordinary skill in the art having the benefit of this disclosure processor 150 may include one or more processors that work in conjunction with each other. Each antenna (including virtual antennas and supplemented virtual antennas) in the second supplemental virtual array 130 can contribute both elevation and azimuthal information to track one or more targets.

FIG. 1E illustrates an example emulated virtual array 140 developed by a neural network based on the physical antenna array 100 shown in FIG. 1A. In some embodiments the neural network can create data for every antenna of the emulated array using data from the physical array shown in FIG. 1A, and/or from the virtual array shown in FIG. 1B. In various embodiments the neural network may directly generate the emulated array without using data from an intermediate virtual array. The number of generated emulated array antennas may be determined by the neural network and can be set at any suitable number. The horizontal and/or spacing between each virtual antenna in the emulated array may be λ/2. In some embodiments a neural network may not be employed and one or more processors may generate data corresponding to the emulated virtual array 140 using an extrapolation calculation or other suitable algorithm.

In some embodiments the neural networks described herein may be configured to perform joint processing of both azimuth and elevation data for an array. More specifically in one example all physical transmit antennas are at a same elevation and one or more receive antennas are at a different elevation as compared to the other receive antennas. In another example, one or more physical transmit antennas have a different elevation as compared to the other transmit antennas while all receive antennas are at a same elevation. In a yet further example one or more physical transmit antennas have a different elevation as compared to the other transmit antennas and one or more receive antennas are at a different elevation as compared to the other receive antennas. In each of these examples the neural network may be configured to perform joint azimuth and elevation processing of the supplemental virtual antennas and or the emulated virtual antennas. In some embodiments the neural network may perform the joint processing in a same stage or in different stages.

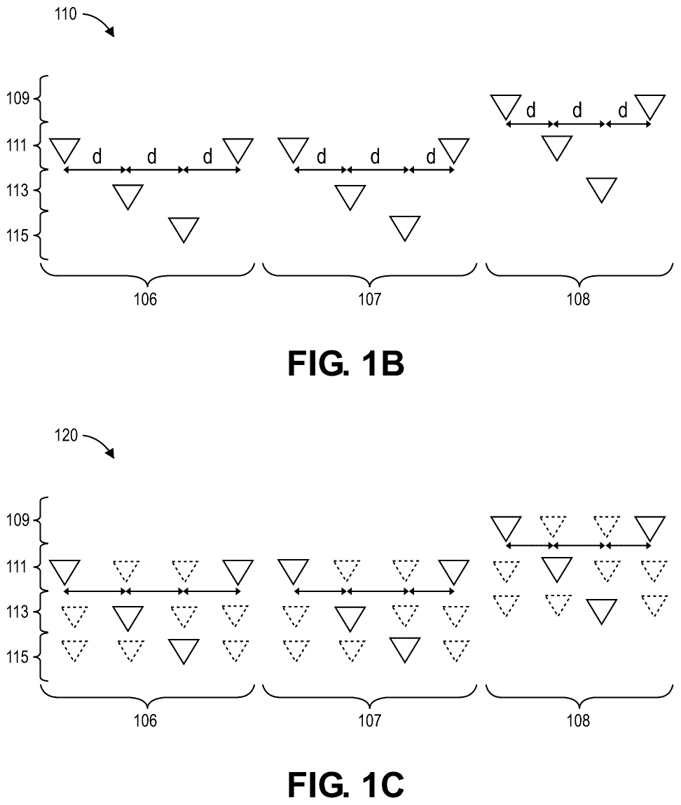

FIG. 2 is an example block diagram of how radar system 100 shown in FIG. 1A may work, according to embodiments of the disclosure. As shown in FIG. 2, raw data from the radar array (e.g., from processor 150, receive antennas and/or transmit antennas) enters range processing 205 where ranges of the targets are processed. Data is transferred from range processing to a doppler processing 210 before slicing 215 takes place. The sliced data is transferred to a Constant False Alarm Rate (CFAR) processing 220 which may be used to detect target returns against a background of noise, clutter, and interference. The results of the CFAR analysis may then be used to generate supplemental virtual antenna elements (see FIG. 1C or FIG. 1D) via a trained generative neural network 225. Data from the supplemental virtual antenna elements (see FIG. 1C or FIG. 1D), from the virtual antenna elements (see FIG. 1C or FIG. 1D) and optionally from the physical antenna elements (see FIG. 1A) is transferred to angle processing 230, from which angle information is derived.

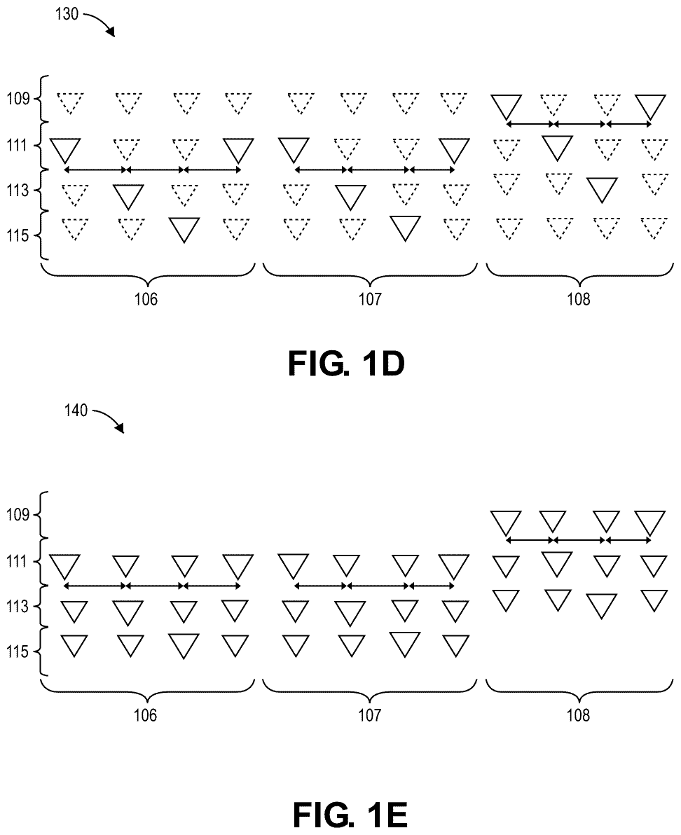

FIG. 3 illustrates a simplified model 300 of one embodiment of the generation of a supplemental virtual antenna using a neural network model. This generator network may be responsible for generating data for the missing virtual antennas (e.g., supplemental virtual antennas). The training process allows the generator to improve over time and produce more realistic samples. As shown in FIG. 3 the sparse input signal may be part of a sampled continuous signal. Note that the samples are defined in a space dimension, which are the data received from antennas. The generated samples by the neural network correspond to the signals of the missing antennas in angle domain of the radar. These signals can be alternatively used along with the signals from original receivers for angle processing. Angle processing data may be used to generate angle information for the target(s).

The integration of a neural network with sparse antennas may be used to transform the radar system from a discrete-time low-resolution signal to a high-resolution signal within the network architecture. In some embodiments the network may be based on a Tensorflow Processing Units (TPU) or other suitable approach that utilizes distributed antennas in conjunction with the neural network.

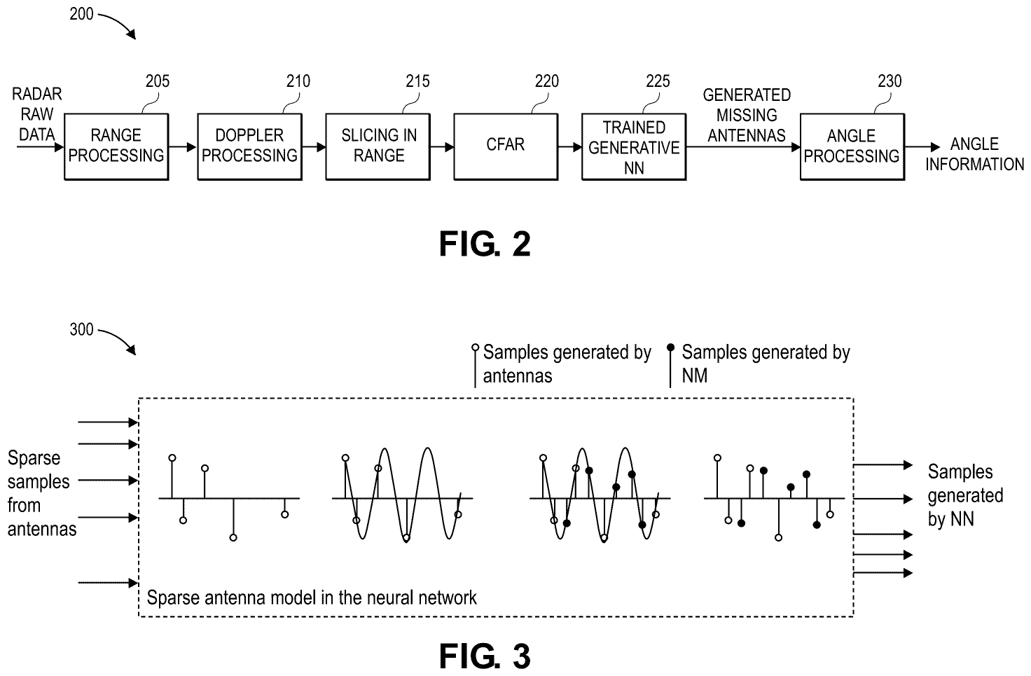

FIG. 4 illustrates a high-level depiction of a machine learning-based neural network model 400, according to embodiments of the invention. As shown in FIG. 4, the neural network can be used to generate the data for supplemental antennas using the trained model and may be based on the locations of the antennas. In some embodiments the system may generate supplemental antenna elements.

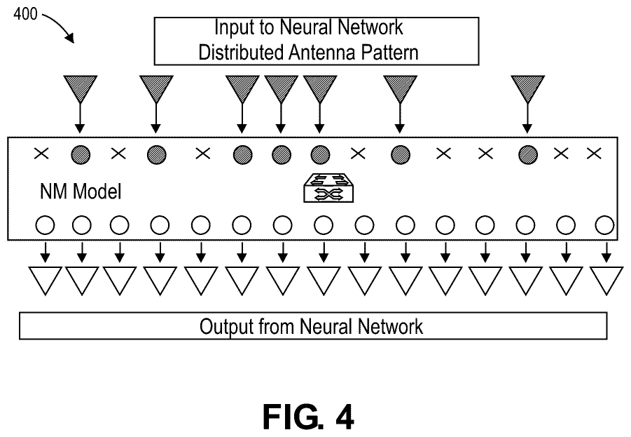

FIG. 5 illustrates example steps associated with a method of training a machine learning model 500, according to embodiments of the disclosure. As shown in FIG. 5, the training may apply in the angle domain if the focus is on improved angular resolution or in the elevation domain if the focus is on improved elevation resolution, however, other embodiments may employ different suitable training algorithms. In some embodiments, the deep learning network, or any other suitable neural network model, is capable of learning and capturing patterns within the underlying data. In one example a dataset comprising 10,000 instances is generated, e.g., test scenarios, that represent typical test scenarios. This dataset may consist of both real and imaginary data, enabling the deep learning network to learn and model the patterns effectively.

Datasets may be divided into three subsets: training, validation, and test. The division may be used to assess the accuracy of the trained model by comparing its predictions to actual data and determining the level of agreement between them. In order to have data available for evaluation, a portion of the dataset may be set aside before the training process begins. In one example 20% of the data is reserved for validation, 20% is used for testing, and the remainder of 60% is used to train the model.

A person of skill in the art, with the benefit of this disclosure, will appreciate that, in other embodiments, the machine learning model 500 may have variations, modifications and alternatives that are within the scope of this disclosure. For example, the machine learning model 500 describes several functions including DNN, TinyML Keras, Tensorflow, however this disclosure is not limited to these disclosed functions and other suitable functions can be used in addition to or in place of the disclosed function. In one example, a CNN model may be used in place of the DNN model. Further, the order of the steps disclosed in the machine learning model 500 may be changed.

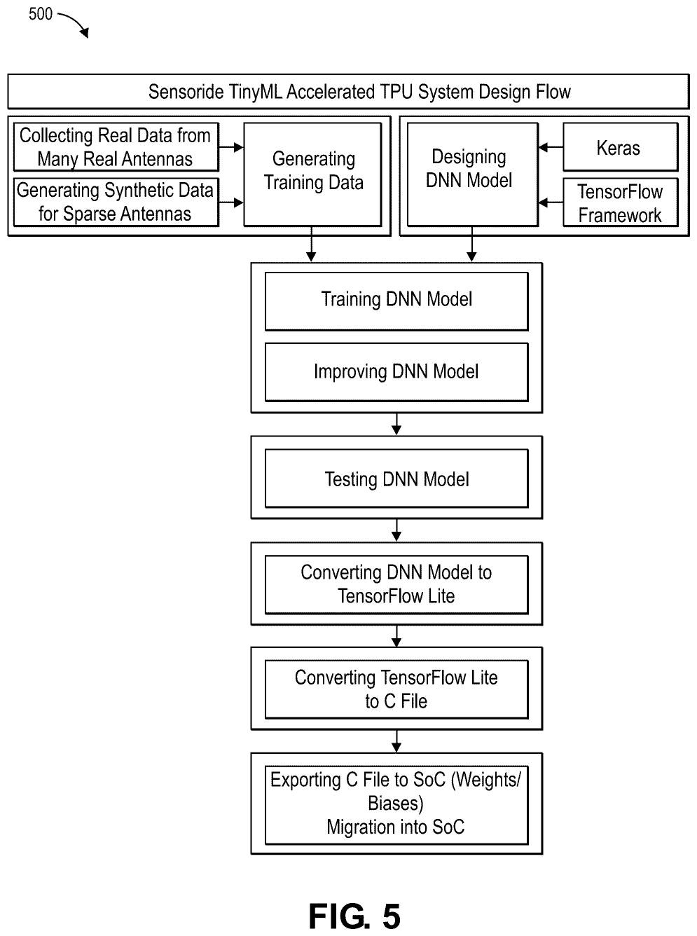

FIG. 6 illustrates on example of a simplified process 600 for generating training data for the machine learning model, according to embodiments of the disclosure. Other suitable training processes may be used. As shown in FIG. 6, real-world field data may be used to train the model. The data used for training the neural networks may include three types of radar input, which are outlined below:
Theoretical data: Preliminary radar data, typically system generated and used in simulations for algorithm development.
Real-world field data: Radar data gathered from selected scenarios (e.g., a pedestrian).
Hybrid data: Creating numerous synthetic scenarios using a subset of real-world measurements that effectively replicate hundreds of challenging scenarios of interest.

A training data set may be created from the real-world field data as the baseline and then adjustments can be made to the phase, amplitude, and duplications, including normalization. The model's ability to effectively learn from the data and achieve accurate detection performance in radar applications is evaluated during the training. This evaluation may be carried out by calculating, for example, both a loss metric and an error metric:
Loss Metric: This is the output of the loss function which may be mean squared error, which is expressed as a positive number. Generally, the smaller the loss value, the better.
Mean Absolute Error (MAE) Metric: This is the mean absolute error of the training data. It shows the average difference between the network's output regression and the expected values from the training data.

The trained model may utilize signals from the physical sparse antennas as input and generate a set of additional and new virtual antennas as output. This specific problem falls under the category of regression, where the model aims to predict continuous phase values based on the given input. To develop the model, any suitable neural network architecture may be used that consists of layers of interconnected neurons that aim to learn patterns and relationships within the training radar data to make accurate estimations.

Direct Generation of Fully or Partially Processed Output Data from Neural Network

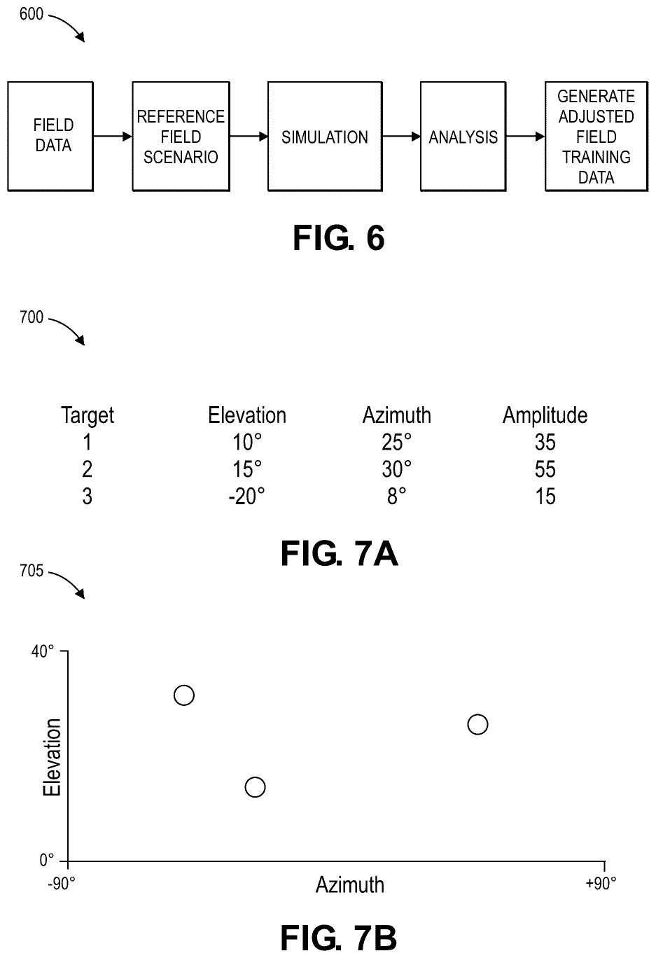

FIG. 7A illustrates example fully or partially processed output data 700 that may be generated by a neural network, according to embodiments of the disclosure. As shown in FIG. 7A target data that may include elevation, azimuth and or reflected signal aka RCS (radar cross section) amplitude for each target may be generated by the neural network. In some embodiments the neural network may directly generate fully or partially processed output data, without generating data corresponding to a virtual antenna array. In various embodiments the neural network may be trained to directly generate the fully or partially processed output data 700 based on various different input data, such that the neural network generates the fully or partially processed output data without calculating and/or generating data representative of a virtual antenna array. In some embodiments, by not performing the intermediate virtual antenna array calculations the speed, accuracy and/or efficiency of the neural network may be improved.

FIG. 7B illustrates another example of fully or partially processed output data 705 that may be generated by a neural network or by a processor using an extrapolation calculation or other suitable algorithm. As shown in FIG. 7B, azimuth and elevation data may be generated by the neural network or algorithm, and shown for three targets. In some embodiments the targets may be color coded or represented with different shapes to provide information with regard to the amplitude of the corresponding signal. FIGS. 7A and 7B are only examples of fully or partially processed output data, one of skill in the art having the benefit of this disclosure will appreciate other suitable fully or partially processed output data may be generated.

### Example Processor

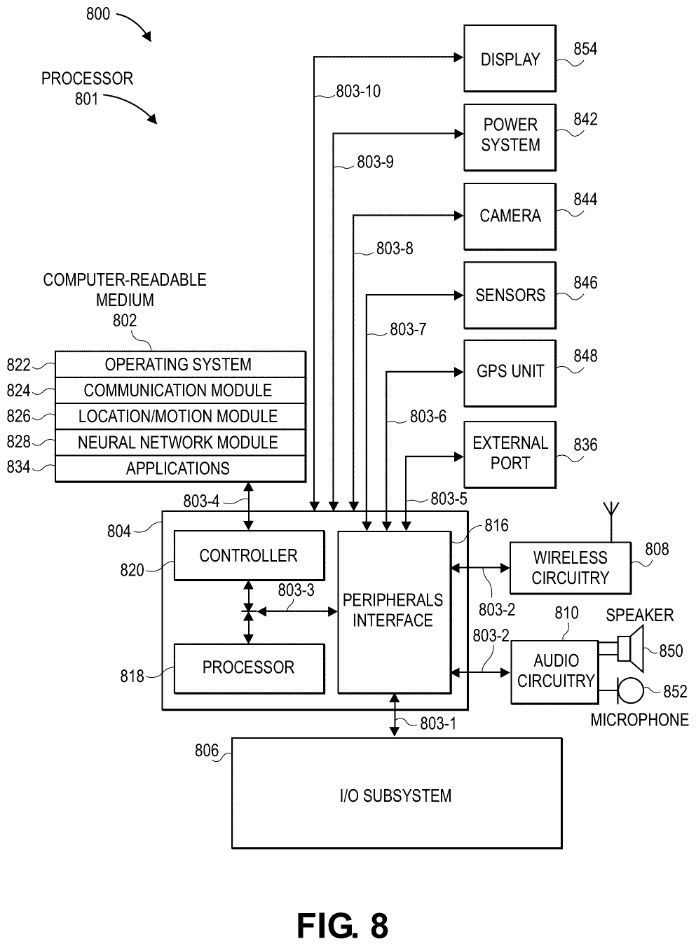

FIG. 8 is a block diagram 800 of an example processor 150 (see FIG. 1A) that may be used to operate a radar system having an array of physical antennas to generate an array of virtual antennas with continuous phase, according to embodiments of the disclosure. Processor 150 may be one or more semiconductor devices including but not limited to a system on a chip (SOC), a multi-chip module, a field programmable gate array (FPGA) or other suitable device. In some embodiments, processor 150 may include a computer-readable medium (memory) 802, a processing system 804, an Input/Output (I/O) subsystem 806, wireless circuitry 808, and audio circuitry 810 including speaker 850 and microphone 852. These components may be coupled by one or more communication buses or signal lines 803. Processor 150 can encompass any suitable processing device and/or portable electronic device, including a handheld computer, a tablet computer, a remote control unit for a drone, a mobile phone, laptop computer, tablet device, media player, a wearable device, personal digital assistant (PDA), a multi-function device, a mobile phone, a portable gaming device, a car display unit, or the like, including a combination of two or more of these items.

The processor 150 can be a system on chip (SOC) which may be an RF device with an embedded processor or can be any other suitable processor in accordance with some embodiments. The touch screen optionally displays one or more graphics within user interface (UI). In some embodiments, a user is enabled to select one or more of the graphics by making a gesture on the graphics, for example, with one or more fingers or one or more styluses. In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with processor 150. In some implementations or circumstances, inadvertent contact with a graphic does not select the graphic. For example, a swipe gesture that sweeps over an application icon optionally does not select the corresponding application when the gesture corresponding to selection is a tap. Processor 150 can optionally also include one or more physical buttons, such as “home” or menu button. As menu button is, optionally, used to navigate to any application in a set of applications that are, optionally executed on the processor 150. Alternatively, in some embodiments, the menu button is implemented as a soft key in a graphical user interface displayed on touch screen.

The processor 150 can incorporate a display 854. The display 854 can be a LCD, OLED, AMOLED, Super AMOLED, TFT, IPS, or TFT-LCD that typically can be found a computing device. The display 854 may be a touch screen display of a computing device.

In one embodiment, processor 150 includes touch screen, menu button, push button for powering the device on/off and locking the device, volume adjustment button(s), Subscriber Identity Module (SIM) card slot, head set jack, and docking/charging external port. Push button is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, processor 150 also accepts verbal input for activation or deactivation of some functions through microphone. Processor 150 also, optionally, includes one or more contact intensity sensors for detecting intensity of contacts on touch screen and/or one or more tactile output generators for generating tactile outputs for a user of processor 150.

In one illustrative configuration, processor 150 may include at least one computer-readable medium (memory) 802 and one or more processing units (or processor(s)) 818. Processor(s) 818 may be implemented as appropriate in hardware, software, or combinations thereof. Computer-executable instruction or firmware implementations of processor(s) 818 may include computer-executable instructions written in any suitable programming language to perform the various functions described.

Computer-readable medium (memory) 802 may store program instructions that are loadable and executable on processor(s) 818, as well as data generated during the execution of these programs. Depending on the configuration and type of processor 150, memory 802 may be volatile (such as random access memory (RAM)) and/or non-volatile (such as read-only memory (ROM), flash memory, etc.). Processor 150 can have one or more memories. Processor 150 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the devices. In some implementations, memory 802 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

Memory 802 and additional storage, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. Memory 802 and additional storage are both examples of non-transitory computer storage media. Additional types of computer storage media that may be present in processor 150 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by processor 150. Combinations of any of the above should also be included within the scope of non-transitory computer-readable storage media. Based on the disclosure and teachings provided herein, a person of ordinary skill in the art can appreciate other ways and/or methods to implement the various embodiments. However, as noted above, computer-readable storage media does not include transitory media such as carrier waves or the like.

Alternatively, computer-readable communication media may include computer-readable instructions, program modules, or other data transmitted within a data signal, such as a carrier wave, or other transmission. However, as used herein, computer-readable storage media does not include computer-readable communication media.

Processor 150 may also contain communications connection(s) 808 that allow processor 150 to communicate with a data store, another device or server, user terminals and/or other devices via one or more networks. Such networks may include any one or a combination of many different types of networks, such as cable networks, the Internet, wireless networks, cellular networks, satellite networks, other private and/or public networks, or any combination thereof. Processor 150 may also include I/O device(s) 806, such as a touch input device, a keyboard, a mouse, a pen, a voice input device, a display, a speaker, a printer, etc.

It should be apparent that the architecture shown in FIG. 8 is only one example of an architecture for processor 150, and that processor 150 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 808 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 808 can use various protocols, e.g., as described herein. For example, wireless circuitry 808 can have one component for one wireless protocol (e.g., Bluetooth®) and a separate component for another wireless protocol (e.g., UWB). Different antennas can be used for the different protocols.

Wireless circuitry 808 is coupled to processing system 804 via peripherals interface 816. Interface 816 can include conventional components for establishing and maintaining communication between peripherals and processing system 804. Voice and data information received by wireless circuitry 808 (e.g., in speech recognition or voice command applications) is sent to one or more processors 818 via peripherals interface 816. One or more processors 818 are configurable to process various data formats for one or more application programs 834 stored on computer-readable medium (memory) 802.

Peripherals interface 816 couple the input and output peripherals of the device to processor(s) 818 and computer-readable medium 802. One or more processors 818 communicate with computer-readable medium 802 via a controller 820. Computer-readable medium 802 can be any device or medium that can store code and/or data for use by one or more processors 818. Medium 802 can include a memory hierarchy, including cache, main memory, and secondary memory.

Processor 150 also includes a power system 842 for powering the various hardware components. Power system 842 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management, and distribution of power in mobile devices.

In some embodiments, processor 150 includes a camera 844. In some embodiments, processor 150 includes sensors 846. Sensors 846 can include accelerometers, compasses, gyrometers, pressure sensors, audio sensors, light sensors, barometers, and the like. Sensors 846 can be used to sense location aspects, such as auditory or light signatures of a location.

In some embodiments, processor 150 can include a GPS receiver, sometimes referred to as a GPS unit 848. A mobile device can use a satellite navigation system, such as the Global Positioning System (GPS), to obtain position information, timing information, altitude, or other navigation information, including for one or more targets detected by the radar system. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 818 run various software components stored in medium 802 to perform various functions for processor 150. In some embodiments, the software components include an operating system 822, a communication module (or set of instructions) 824, a location module (or set of instructions) 826, a bounding path 828 that is used as part of ranging operation described herein, and other applications (or set of instructions) 834.

Operating system 822 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components. An operating system 822 is system software that manages computer hardware and software resources and provides common services for computer programs. For example, the operating system 822 can manage the interaction between the user interface module and one or more user application(s). The various embodiments further can be implemented in a wide variety of operating environments, which in some cases can include one or more user computers, devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Communication module 824 facilitates communication with other devices over one or more external ports 836 or via wireless circuitry 808 and includes various software components for handling data received from wireless circuitry 808 and/or external port 836. External port 836 (e.g., USB, FireWire, Lightning connector, 60-pin connector, etc.) is adapted for coupling directly to other devices or indirectly over a network (e.g., the Internet, wireless LAN, etc.).

Location/motion module 826 can assist in determining the current position (e.g., coordinates or other geographic location identifiers) and motion of processor 150 and/or one or more target detected by the radar system. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 826 receives data from GPS unit 848 and analyzes the signals to determine the current position of the mobile device. In some embodiments, location/motion module 826 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 808 and is passed to location/motion module 826. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for processor 150 based on the position coordinates of the corresponding transmitters. Regardless of the specific location technology used, location/motion module 826 receives information from which a location fix can be derived, interprets that information, and returns location information, such as geographic coordinates, latitude/longitude, or other location fix data.

The neural network module 828 can be employed with sparse antennas and used to generate a new radar data with continuous phase from a discrete-time physically sparse signal configuration within the network architecture. In some embodiments the network may be based on a Tensorflow Processing Units (TPU) approach that utilizes sparse antennas in conjunction with the neural network. The neural network can be trained based on machine learning model based on perception, including Deep Neural Networks (DNN) and convolutional neural network (CNN). In some embodiments the neural network may undergo training to understand patterns and correlations within the available radar data, enabling the network to estimate the signals for the generated virtual antennas.

The one or more applications programs 834 on the mobile device can include any applications installed on the processor 150, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations and the like) on a display surface. In another example, a timer module can be a software timer. The timer module can also be implemented in hardware. The timer module can maintain various timers for any number of events.

The I/O subsystem 806 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 806 can include a display and user input devices such as a keyboard, mouse, and/or track pad. In some embodiments, I/O subsystem 806 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 802) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, processor 150 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art can appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically can include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other devices such as network input/output devices may be employed.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

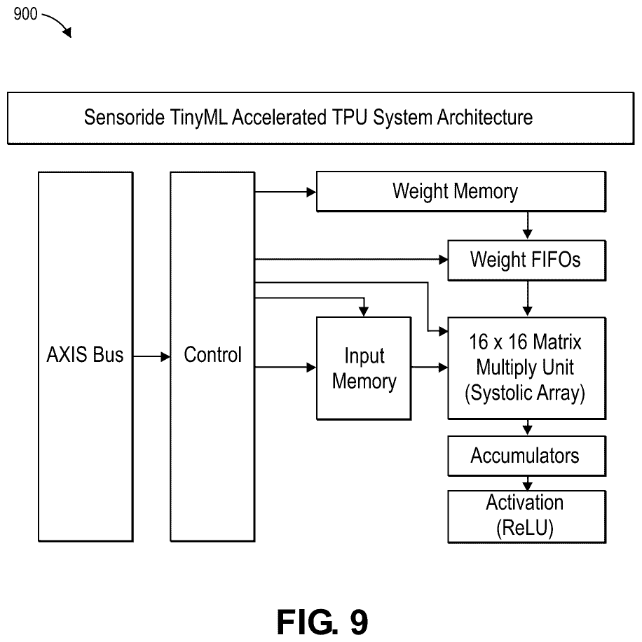

FIG. 9 illustrates an architecture 900 of integrating the generated model into a hardware-accelerated architecture based on a FPGA. As shown in FIG. 9, the commands and data are transferred through the PS interface using the AXIS bus. Upon reception, these commands are decoded and directed to one of the following functions:
Write Weight Memory: Data on the bus is written into a specific location in Weight Memory space.
Write Input Memory: Data on the bus is written onto a specified location in Input Memory space.
Fill Weight FIFO's: A set of weights is read from weight memory into the weight FIFO's.
Drain Weight FIFO's: A set of weights currently held in the weight FIFOs is loaded into the systolic array.
Matrix Multiply: A set of inputs is piped into the systolic array and multiplied with the set of weights currently held in the array.
Read Output Memory: A specified word from memory is read to the host.

The architecture may utilize a weight stationary systolic array, which operates by loading a set of weights once and reusing them for multiple operations. This array may be fully pipelined and can perform a 16×16 matrix multiplication in 32 cycles. The systolic array consists of multiple processing elements (PEs) that contain a small amount of memory and control logic, along with a single multiply-accumulate data path. The execution of a complete matrix multiplication starts from the top left corner of the systolic array and progresses diagonally downward in a pipelined fashion.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A radar system comprising:
a physical radar array comprising:
a plurality of physical transmit antennas, each configured to transmit a respective signal having a wavelength λ; and
a plurality of physical receive antennas, each configured to receive each of the respective signals, wherein at least a first physical receive antenna of the plurality of physical receive antennas is at an elevation that is different than a second physical receive antenna of the plurality of receive antennas.

2. The radar system of claim 1, further comprising a processor arranged to receive data from the physical radar array and to generate data for a two-dimensional virtual antenna array, wherein a spacing between a first and a second virtual antenna of the virtual antenna array is greater than λ/2.

3. The radar system of claim 2, wherein the processor is further arranged to generate data for a supplemental virtual antenna positioned between the first and the second virtual antenna.

4. The radar system of claim 3, wherein the processor employs a trained neural network to generate the data.

5. The radar system of claim 3, wherein a distance between the first virtual antenna and the supplemental virtual antenna is λ/2 and wherein a distance between the second virtual antenna and the supplemental virtual antenna is λ/2.

6. The radar system of claim 1, wherein at least a first physical transmit antenna of the plurality of physical transmit antennas is at an elevation that is different than a second physical transmit antenna of the plurality of physical transmit antennas.

7. The radar system of claim 1, further comprising a processor arranged to receive data from the physical radar array and to generate data for a two-dimensional emulated virtual antenna array.

8. The radar system of claim 7, wherein a horizontal distance between each virtual antenna of the emulated virtual antenna array is λ/2.

9. The radar system of claim 7, wherein the processor employs a trained neural network to generate the data.

10. A radar system comprising:
a physical transmit antenna configured to transmit a signal having a wavelength λ;
a first physical receive antenna positioned at a first vertical position and arranged to receive a reflected signal corresponding to the transmitted signal; and
a second physical receive antenna positioned at a second vertical position and arranged to receive the reflected signal corresponding to the transmitted signal, wherein the first vertical position is higher than the second vertical position.

11. The radar system of claim 10, further comprising a processor arranged to receive data from the first physical receive antenna and from the second physical receive antenna, the processor further arranged to generate data for a two-dimensional virtual antenna array, wherein a spacing between a first and a second virtual antenna of the virtual antenna array is greater than λ/2.

12. The radar system of claim 11, wherein the processor is further arranged to generate data for a supplemental virtual antenna positioned between the first and the second virtual antenna.

13. The radar system of claim 12, wherein the processor employs a trained neural network to generate the data.

14. The radar system of claim 13, wherein a distance between the first virtual antenna and the supplemental virtual antenna is λ/2, and wherein a distance between the second virtual antenna and the supplemental virtual antenna is λ/2.

15. The radar system of claim 10, further comprising a processor arranged to receive data from the first physical receive antenna and from the second physical receive antenna, the processor further arranged to generate data for a two-dimensional emulated virtual antenna array.

16. The radar system of claim 7, wherein the processor employs a trained neural network to generate the data such that a horizontal distance between each virtual antenna of the emulated virtual antenna array is λ/2.

17. A method of operating a radar system, the method comprising:
transmitting a signal from a physical transmit antenna at a wavelength (λ);
receiving a reflected signal at a first physical receive antenna positioned at a first elevation, wherein the reflected signal corresponds to the transmitted signal; and
receiving the reflected signal at a second physical receive antenna positioned at a second elevation, wherein the reflected signal corresponds to the transmitted signal; and
wherein the first elevation is greater than the second elevation.

18. The method of claim 17, wherein the method further comprises, generating, using a processor, data corresponding to a virtual antenna array, wherein a horizontal distance between a first virtual antenna of the virtual antenna array and a second virtual antenna of the virtual antenna array is greater than λ/2.

19. The method of claim 18, wherein the processor is further arranged to generate data for a supplemental virtual antenna positioned between the first virtual antenna of the virtual antenna array and the second virtual antenna of the virtual antenna array.

20. The method of claim 17, wherein the method further comprises, generating, using a processor, data corresponding to an emulated virtual antenna array, wherein a horizontal distance between a first virtual antenna of the emulated virtual antenna array and a second virtual antenna of the emulated virtual antenna array is λ/2.
